(19) United States
(12) Patent Application Publication
(10) Pub. No.: US 2024/0260527 A1
(43) Pub. Date: Aug. 8, 2024

(54) Photobioreactor System for Algae and Microorganisms

(71) Applicant: Nicholas Scott Reimnitz, Mammoth Lakes, CA (US)

(72) Inventor: Nicholas Scott Reimnitz, Mammoth Lakes, CA (US)

(21) Appl. No.: 18/164,756

(22) Filed: Feb. 6, 2023

(51) Int. Cl. A01G 33/00

(52) U.S. Cl. CPC A01G 33/00

(57) ABSTRACT

The present invention relates to an advancement in a system primarily designed to be used for the cultivation of spirulina. It provides the basic necessities of algae growth, including fresh air exchange, light, and heat. It also monitors environmental variables, including at least temperature and pH. It transmits this information wirelessly via either Bluetooth or WIFI antennas, to an external system for recording and/or monitoring. Information from the sensors may also be used to form a closed feedback loop to control output of the systems controlling the liquid culture.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The instant invention relates generally to and more specifically it relates to a system controlling a liquid culture of microorganisms such as cyanobacteria or other living organisms in a closed photobioreactor, including sensors and actuators which may monitor and maintain the environment, with the intention of creating an environment conducive to the growth of said organisms.

### Description of the Related Art

Cyanobacteria cultivation is currently a process which is most commonly undertaken by professional farming operations, which produce a relatively large amount of algae. Although they may use control systems similar to what are described, (to my knowledge) there does not yet exist a consumer product which enables the functionality on a smaller level. Typically, a home user would use a fish tank and some combination of non-integrated sensors and actuators to grow and maintain an algae culture. Additionally, this system provides remote data monitoring and control of the functional systems via an external method, such as an app on a smartphone.

This invention relates to an arrangement for cultivating microorganisms from a bioreactor at a relatively small scale, and more particularly to equipment for growing microorganisms in a home environment, by using a closed and controlled environment to create conditions amicable to growth.

Prior to the present invention, algae such as spirulina has been cultivated by an individual consumer with success primarily by using fish tanks. Conditions such as light, temperature, pH and the like are carefully monitored and maintained throughout the growing cycle.

By looking at prior art, multiple types of inventions have been seen in similar regards. For instance, a U.S. Pat. No. 8,507,253B2 discloses a photobioreactor system for photosynthetic organisms.

U.S. Pat. No. 9,005,918B2 discloses an algae bioreactor system and process.

U.S. Pat. No. 6,602,703B2 discloses a photobioreactor design for cultivating photosynthetic organisms.

U.S. Pat. No. 20030059932A1 describes a photobioreactor design for the mass production of algae in a pool.

The present invention overcomes the disadvantages of the prior art. It has to be noted that the current invention proposes an advancement where it provides a new approach of a system primarily designed to be used for the cultivation of microorganisms by an individual consumer. This invention pertains primarily to photosynthetic microorganism cultivation, particularly algae such as spirulina. More specifically, it is equipment for the small-scale or consumer-level production of spirulina. It involves sensing and control technologies which are capable of maintaining desired liquid culture conditions within a confined space. A primary object of the present invention is to provide an enhanced approach of a system containing a liquid culture, including sensors and controllers which may monitor and maintain the culture, with the intention of creating an optimal environment for the growth of microorganisms.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve upon prior bioreactor systems and provide an enhanced approach toward better microorganism growth techniques at the individual consumer level.

Another object of the present invention is to provide a system containing a liquid culture, including sensors and controllers which may monitor and maintain culture, with the intention of creating an optimal environment for the growth of microorganisms, particularly spirulina.

It is a further objective of the present invention to provide an enclosed space where the liquid culture is enclosed to make it difficult for contaminants and insects to enter into the space.

It is also an object of the invention to provide fresh air where a diffuser or a plurality of diffusers provide fresh atmospheric air into the culture, ensuring that carbon dioxide and/or oxygen are available to the microorganisms as they grow. Air diffusing through the culture may be able to exhaust from the bioreactor system through a filter above the headspace of the liquid culture. The filters on the inlet and outlet serve to maintain a sterile environment inside of the bioreactor.

It is further the objective of the invention to provide an assembly which includes a heater, as well as a thermal sensor which is able to read the temperature of the liquid culture.

It is also the objective of the invention to provide an assembly where the system will enable a user to set a desired temperature level, which will be maintained using closed loop control between the sensor and the heater.

It is further the objective of invention to provide a system which enables the use of lights, which may be programmed. Light is necessary for algae growth, and the optional light control will enable the system to be placed in an environment devoid of light (such as a closet).

It is also the objective of invention to allow light cycles to be programmed; e.g., 12 hours on, 12 hours off.

It is also the objective of the invention to provide a system which enables the monitoring of pH, which enables a user to make an informed decision as to the timing and frequency of harvesting.

Thus, it is the objective to provide a new and improved form of an advancement in the consumer-scale growth of microorganisms. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 discloses front view of device as per preferred embodiments of the invention.

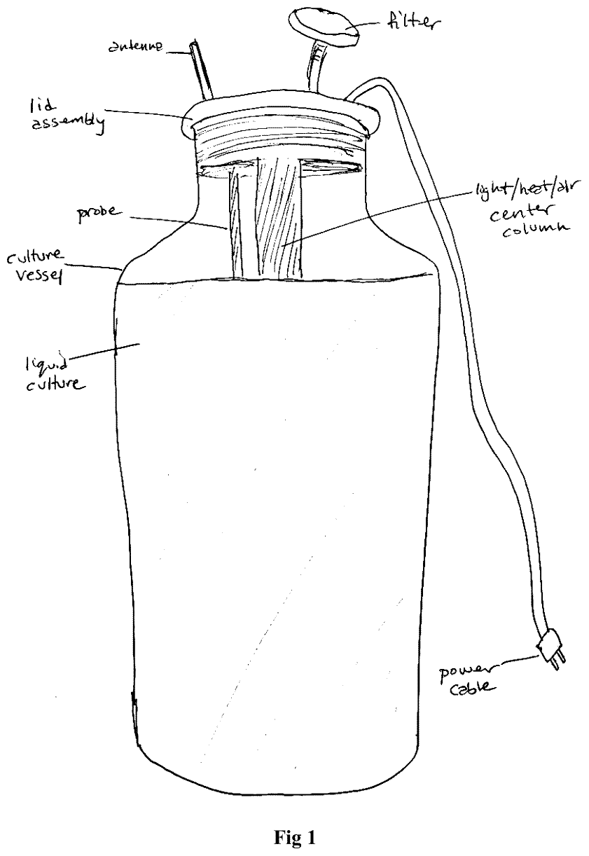

FIG. 2 discloses a cutaway view depicting the configuration of major functional components of the assembly as per preferred embodiments of the invention.

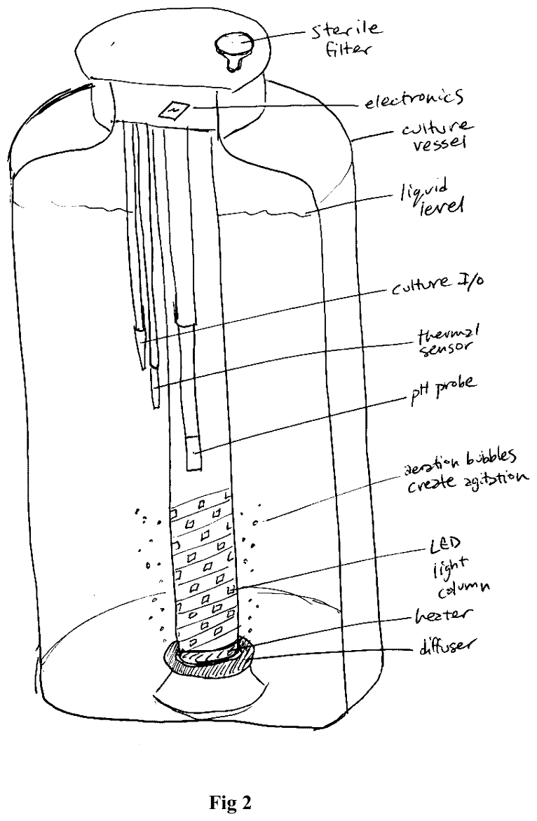

FIG. 3 discloses cutaway view highlighting fresh air pathway and related components along with general culture agitation technique as per preferred embodiments of the invention.

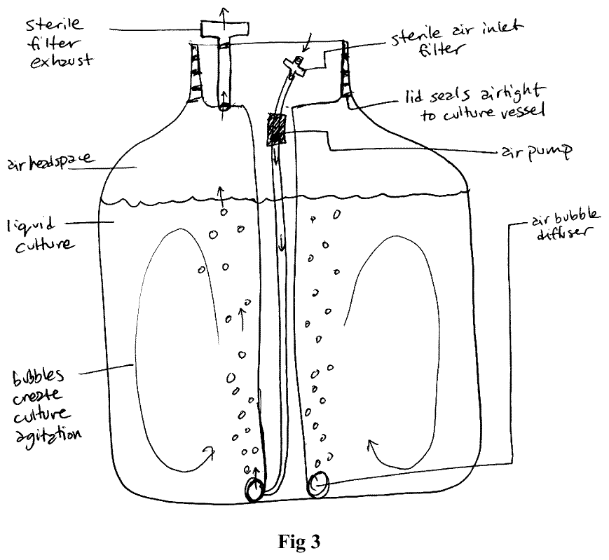

FIG. 4 discloses P&ID for preferred embodiments of the invention.

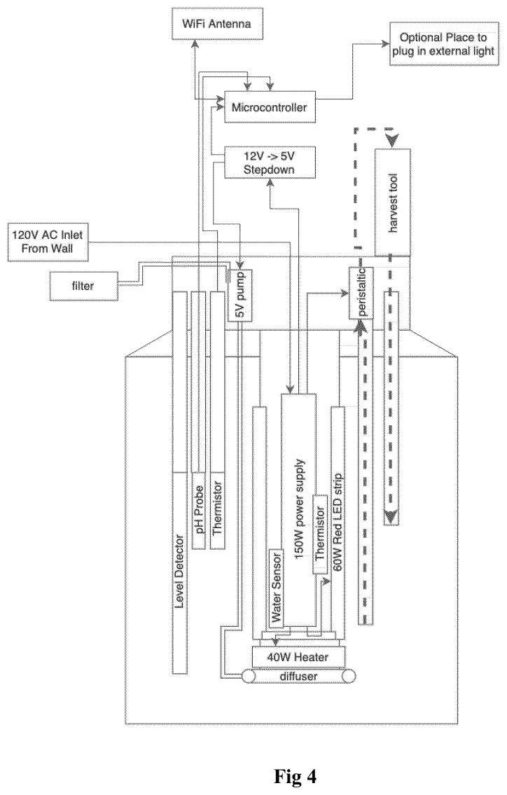

FIG. 5 discloses view of lid and center column of assembly with callout for power supply location as per preferred embodiments of the invention.

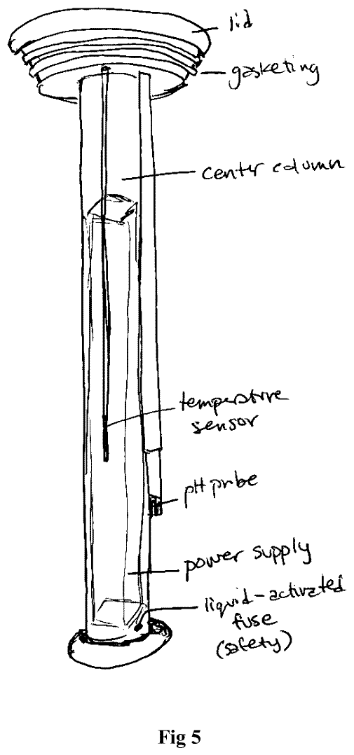

FIG. 6 discloses a potential implementation of a harvesting mechanism with a mesh as per preferred embodiments of the invention.

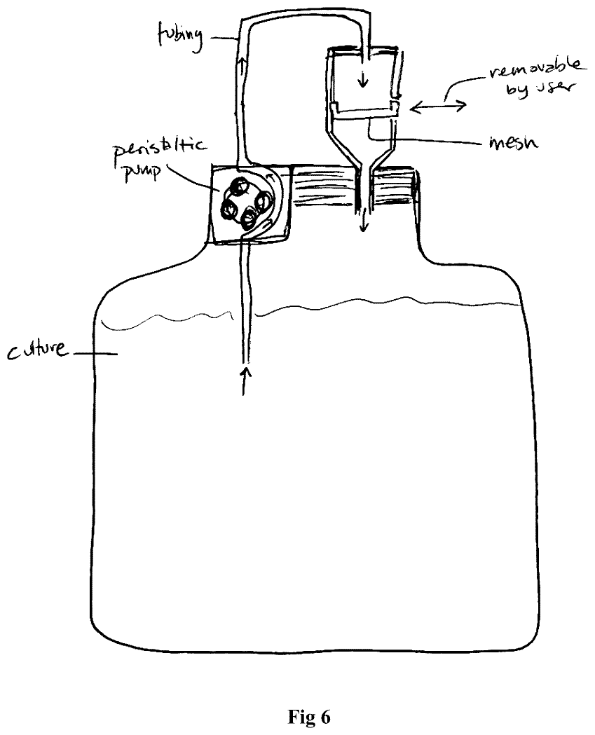

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The cultivation of algae has a venerable history. While algae grows readily in the natural state where it finds a supportive environment, efforts to cultivate algae require great care in order to obtain an economic crop. In producing cultivated algae, a media composition must be provided which enables the growth of the desired strain, and sterile technique should be utilized to discourage the invasion of undesirable bacteria, fungi, or other algae species. During early culture growth, algae is particularly susceptible to variations in their environment and their growth can be substantially or completely inhibited when the environment does not provide the necessary degree of nutrients, temperature, light, and aeration.

An algae which has long been cultivated for nutritional purposes is Spirulina. Its cultivation depends on the proper balancing of culture conditions to create an environment favorable to proliferation. It must receive the necessary nutrients for growth, as well as enough gas exchange to support metabolic activities. Ideally a sterile environment should be maintained in order to limit exposure to competing bacteria, fungi, and microorganisms including other species of algae.

Since the edible algae, and especially fresh live edible algae, is an excellent source of food values, there is an increasing interest in enhancing the ability for an individual to grow algae in an economical manner.

In developing new techniques for growing algae and in working with new species, it is desirable to provide an enhanced scientific approach on a small scale toward developing optimally favorable conditions for higher-scale farming efforts.

The current invention presents an assembly which provides a controllable environment enabling creation of favorable conditions for the growth of algae and other microorganisms, at a scale of approximately 1-10 gallons of liquid culture.

The assembly as per its preferred embodiments presents filters, which is to keep the space free from contaminants and pests, while providing enough fresh air to enable microorganism growth.

The light, especially red light, is required for algae growth. The system as per its further embodiments will include a lighting system to ensure that the algae receives light for growth, even if the system is installed in a location devoid of light, such as a closet. Lighting options may include LED light, fluorescent light, or a different option such as a location to plug in an externally powered high wattage light.

The Temperature is also the required embodiment of invention. As understood, algae grows faster when the temperature is kept around 86-97 degrees Fahrenheit. The goal of the system is to provide ideal conditions, so an effort is ongoing to determine the best option for maintaining heat homogeneously in the liquid culture. This can include but not limited to a resistive heating element wrapped around the center column, or a submersible heating element suspended into the culture. It is also worth noting the lighting system will introduce a significant amount of heat to the culture, and in some situations may be the only necessary source of heat energy.

While a specific embodiment has been shown and described, many variations are possible. With time, additional features may be employed. The particular shape or configuration of the bioreactor or the interior configuration of the controllers, ports, sensors, and probes may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

I: A system designed to be used for the cultivation of microorganisms comprising:
basic necessities of algae growth, including air exchange; temperature control; light.

II: A system to monitor environmental variables, including but not limited to: temperature, pH

III: A system to transmit this information wirelessly via either Bluetooth or WIFI antennas, to an external system for controlling, recording, and/or monitoring. The information from the sensors may also be used to form a closed feedback loop to control output of the systems controlling the liquid culture conditions.
